(19) United States
(12) Patent Application Publication
(10) Pub. No.: US 2014/0093609 A1
(43) Pub. Date: Apr. 3, 2014

(54) NUTRITIONAL COMPOSITIONS FOR ENHANCING PERFORMANCE AND METHODS FOR MAKING AND USING SAME

(71) Applicants: Marie Georgina Roy, Chaux-Neuve (FR); Gilbert Geoffroy, Botterens (CH); Tesfalidet Haile, Boussens (CH)

(72) Inventors: Marie Georgina Roy, Chaux-Neuve (FR); Gilbert Geoffroy, Botterens (CH); Tesfalidet Haile, Boussens (CH)

(73) Assignee: NESTEC S.A., Vevey (CH)

(21) Appl. No.: 14/111,805

(22) PCT Filed: Apr. 18, 2012
(86) PCT No.: PCT/US2012/033991

§ 371 Date: Dec. 19, 2013

Related U.S. Application Data
(60) Provisional application No. 61/478,047, filed on Apr. 21, 2011.

(51) Int. Cl. A23L 1/29

(52) U.S. Cl. CPC A23L 1/296
USPC 426/2; 426/590; 426/72; 426/108; 426/599

(57) ABSTRACT

A nutritional composition comprising a carbohydrate fraction comprising glucose and fructose in a ratio from about 3:1 to about 1:1, wherein: the powder nutritional composition is designed to be dissolved in water, a serving size of the nutritional composition is from about 1 to about 20 g, the carbohydrate fraction comprises at least 30% glucose and fructose, the carbohydrate fraction provides at least 50% of the energy of the nutritional composition; and the nutritional composition comprises an energy density from about 800 kJ/100 g to about 2200 kJ/100 g. The performance may be, for example, athletic, academic, or other performances requiring physical stamina and/or mental alertness.

### BACKGROUND

The present disclosure relates generally to health and nutrition. More specifically, the present disclosure relates to nutritional compositions for enhancing performance and methods for making and using same.

There are many types of nutritional compositions currently on the market. Nutritional compositions can be targeted toward certain consumer types, for example, young, elderly, athletic, etc., based on the specific ingredients of the nutritional composition. For example, it is well established that carbohydrate ingestion during or before exercise improves endurance performance, as well as shorter duration exercise. However, nutritional compositions having a proper amount of carbohydrates necessary to fuel the body during exercise may have unappealing characteristics that discourage the athlete from consuming the composition. The performance compositions may be difficult to consume during exercise or may be too dense or heavy for consumption before or during exercise, or may have a chalky or bland taste. As a result, individuals can be less enticed by the taste or appearance of performance compositions and, as a result, may consume smaller amounts of nutritional products containing the necessary carbohydrates to properly fuel the body during performance.

One goal of nutritional support, therefore, is to provide nutritional compositions that can very efficiently provide individuals with carbohydrates and an increased rate of exogenous carbohydrate oxidation during exercise, while at the same time providing an aesthetically and physically well-received product.

### SUMMARY

The nutritional compositions of the present disclosure provide a refreshing and easy to consume composition that provides adequate amounts and types of nutrition to provide the body with proper fuel for performance. The performance may be, for example, athletic, academic, or other performances requiring physical stamina and/or mental alertness. In a general embodiment, a powder nutritional composition including a carbohydrate fraction having glucose and fructose in a ratio from about 3:1 to about 1:1 is provided.

In an embodiment, the powder nutritional composition is designed to be dissolved in water.

In an embodiment, the carbohydrate fraction is at least 30% glucose and fructose. The carbohydrate fraction may also be about 50% glucose and fructose. The carbohydrate fraction may further be at least about 85% glucose and fructose.

In an embodiment, the carbohydrate fraction provides at least 50% of the energy of the nutritional composition, or at least 70% of the energy of the nutritional composition.

In an embodiment, the carbohydrate fraction includes dextrose and/or maltodextrins.

In an embodiment, the nutritional composition includes less than 40 g protein per 100 g nutritional composition.

In an embodiment, the nutritional composition includes less than 20 g fat per 100 g nutritional composition.

In an embodiment, the nutritional composition includes at least one vitamin selected from the group consisting of vitamin C, vitamin E, vitamin B12, niacin, vitamin B6, folic acid, biotin, panthotenic acid, vitamin B2, vitamin B6, or combinations thereof. The at least one vitamin may be present in an amount that is at least 10% of the recommended daily dose.

In an embodiment, the nutritional composition includes at least one electrolyte or mineral selected from the group consisting of sodium, potassium, calcium, iron, magnesium, zinc, or combinations thereof.

In an embodiment, the nutritional composition includes at least one amino acid selected from the group consisting of L-leucine, L-valine, L-isoleucine, or combinations thereof.

In an embodiment, the nutritional composition includes an energy density from about 800 kJ/100 g to about 2200 kJ/100 g.

In an embodiment, a serving size of the nutritional composition is from about 1 to about 20 g, or from about 1 to about 15 g, or from about 1 g to about 6 g.

In an embodiment, the nutritional composition includes at least one compound selected from the group consisting of aroma compounds, fiber, caffeine, guarana, acidifying agents, binding agents, gel building material, fruit, antioxidants, colorings agents, or combinations thereof.

In another embodiment, a liquid nutritional composition comprising a carbohydrate fraction comprising glucose and fructose in a ratio from about 3:1 to about 1:1 is provided.

In an embodiment, a serving size of the liquid nutritional composition is from about 100 mL to about 600 mL. In an embodiment, a serving size of the liquid nutritional composition is about 500 mL.

In yet another embodiment, a packaged food product including an outer package that is so constructed and arranged to house a plurality of inner packages is provided. Each inner package includes a powdered nutritional composition having a carbohydrate fraction including glucose and fructose in a ratio from about 3:1 to about 1:1.

In an embodiment, the outer package is manufactured from a material selected from the group consisting of paperboard, cardboard, plastic, metal or combinations thereof. In an embodiment, the outer package is a cardboard box.

In an embodiment, the plurality of inner packages comprises from about 5 to about 20 inner packages.

In an embodiment, each of the plurality of inner packages includes one serving size of the nutritional composition. The serving size of the nutritional composition may be from about 0.5 g to about 10 g, or from about 1 g to about 6 g, or about 3 g.

In still yet another embodiment, a packaged food product including an outer package that is so constructed and arranged to house a powdered nutritional composition is provided. The powdered nutritional composition includes a carbohydrate fraction having glucose and fructose in a ratio from about 3:1 to about 1:1.

In an embodiment, the outer package includes a food grade coating on an interior surface.

In an embodiment, the outer package further houses a ladle that is constructed to dispense a portion of the nutritional composition from the outer package.

In an embodiment, the outer package is refillable.

In yet another embodiment, a method for making a liquid nutritional composition is provided. The method includes emptying a powdered nutritional composition from a single serving sized packet into a container and combining the powdered nutritional composition in the container with a liquid to form a liquid nutritional composition. The powdered nutritional composition includes a carbohydrate fraction having glucose and fructose in a ratio from about 3:1 to about 1:1.

In another embodiment, a method for making a liquid nutritional composition is provided. The method includes dispensing a powdered nutritional composition from a first container into a second container and combining the powdered nutritional composition in the second container with a liquid to form a liquid nutritional composition. The first container is so constructed and arranged to contain multiple servings of the powdered nutritional composition. The powdered nutritional composition includes a carbohydrate fraction having glucose and fructose in a ratio from about 3:1 to about 1:1.

In still yet another embodiment, a method for improving performance in an individual in need of same is provided. The method includes combining a powdered nutritional composition having a carbohydrate fraction having glucose and fructose in a ratio from about 3:1 to about 1:1 with a liquid to form a liquid nutritional composition and administering the liquid nutritional composition to the individual. In an embodiment, the performance is selected from the group consisting of athletic, academic, endurance, or combinations thereof.

In another embodiment, a method for providing sustained energy to muscles in an individual in need of same is provided. The method includes combining a powdered nutritional composition having a carbohydrate fraction having glucose and fructose in a ratio from about 3:1 to about 1:1 with a liquid to form a liquid nutritional composition and administering the liquid nutritional composition to the individual.

In yet another embodiment, a method for providing an adequate carbohydrate load to an athlete in need of same is provided. The method includes combining a powdered nutritional composition having a carbohydrate fraction having glucose and fructose in a ratio from about 3:1 to about 1:1 with a liquid to form a liquid nutritional composition and administering the liquid nutritional composition to the individual.

An advantage of the present disclosure is to provide improved nutritional compositions.

Another advantage of the present disclosure is to provide nutritional compositions that are appealing to consumers.

Another advantage of the present disclosure is to provide nutritional compositions that provide a consumer with adequate carbohydrates for exercise.

Yet another advantage of the present disclosure is to provide nutritional compositions that are enjoyable to prepare for the consumer.

Still yet another advantage of the present disclosure is to provide nutritional compositions that help to improve recovery from physical activity.

Another advantage of the present disclosure is to provide nutritional compositions that provide adequate nutrition for physical activity.

Yet another advantage of the present disclosure is to provide methods for making improved nutritional compositions.

Still yet another advantage of the present disclosure is to provide methods for providing an individual in need of same with adequate nutrition for physical activity.

Another advantage of the present disclosure is to provide methods for providing an individual in need of same with nutritional compositions to improve recovery from physical activity.

Yet another advantage of the present disclosure is to provide methods for improving athletic performance in an individual in need of same.

Additional features and advantages are described herein, and will be apparent from the following Detailed Description and the figures.

### BRIEF DESCRIPTION OF THE FIGURES

FIG. 1 shows a packaged food product in accordance with an embodiment of the present disclosure.

FIGS. 2A-2C demonstrate a method for making a food product in accordance with an embodiment of the present disclosure.

FIGS. 3A-3E show different embodiments for food packages in accordance with an embodiment of the present disclosure.

FIG. 4 shows a packaged food product in accordance with an embodiment of the present disclosure.

### DETAILED DESCRIPTION

As used herein, “about” is understood to refer to numbers in a range of numerals. Moreover, all numerical ranges herein should be understood to include all integer, whole or fractions, within the range.

As used herein the term “amino acid” is understood to include one or more amino acids. The amino acid can be, for example, alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

As used herein, the term “antioxidant” is understood to include any one or more of various substances such as beta-carotene (a vitamin A precursor), vitamin C, vitamin E, and selenium) that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include astaxanthin, carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin C, vitamin E, zeaxanthin, or combinations thereof.

While the terms “individual” and “patient” are often used herein to refer to a human, the invention is not so limited. Accordingly, the terms “individual” and “patient” refer to any animal, mammal or human having or at risk for a medical condition that can benefit from the treatment.

As used herein, sources of ω-3 fatty acids include, for example, fish oil, krill, plant sources of ω-3, flaxseed, walnut, and algae. Examples of ω-3 fatty acids include, for example, α-linolenic acid (“ALA”), docosahexaenoic acid (“DHA”), eicosapentaenoic acid (“EPA”), or combinations thereof.

As used herein, the term “minerals” is understood to include boron, calcium, chromium, copper, iodine, iron, magnesium, manganese, molybdenum, nickel, phosphorus, potassium, selenium, silicon, tin, vanadium, zinc, or combinations thereof.

“Nutritional products,” or “nutritional compositions,” as used herein, are understood to include any number of optional additional ingredients, including conventional food additives (synthetic or natural), for example one or more acidulants, additional thickeners, buffers or agents for pH adjustment, chelating agents, colorants, emulsifies, excipient, flavor agent, mineral, osmotic agents, a pharmaceutically acceptable carrier, preservatives, stabilizers, sugar, sweeteners, texturizers, and/or vitamins. The optional ingredients can be added in any suitable amount. The nutritional products or compositions may be a source of complete nutrition or may be a source of incomplete nutrition.

As used herein the term “patient” is understood to include an animal, especially a mammal, and more especially a human that is receiving or intended to receive treatment, as it is herein defined.

As used in this disclosure and the appended claims, the singular forms “a,” “an” and “the” include plural referents unless the context clearly dictates otherwise. Thus, for example, reference to “a polypeptide” includes a mixture of two or more polypeptides, and the like.

The terms “protein,” “peptide,” “oligopeptides” or “polypeptide,” as used herein, are understood to refer to any composition that includes, a single amino acids (monomers), two or more amino acids joined together by a peptide bond (dipeptide, tripeptide, or polypeptide), collagen, precursor, homolog, analog, mimetic, salt, prodrug, metabolite, or fragment thereof or combinations thereof. For the sake of clarity, the use of any of the above terms is interchangeable unless otherwise specified. It will be appreciated that polypeptides (or peptides or proteins or oligopeptides) often contain amino acids other than the 20 amino acids commonly referred to as the 20 naturally occurring amino acids, and that many amino acids, including the terminal amino acids, may be modified in a given polypeptide, either by natural processes such as glycosylation and other post-translational modifications, or by chemical modification techniques which are well known in the art. Among the known modifications which may be present in polypeptides of the present invention include, but are not limited to, acetylation, acylation, ADP-ribosylation, amidation, covalent attachment of a flavanoid or a heme moiety, covalent attachment of a polynucleotide or polynucleotide derivative, covalent attachment of a lipid or lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycation, glycosylation, glycosylphosphatidyl inositol (“GPI”) membrane anchor formation, hydroxylation, iodination, methylation, myristoylation, oxidation, proteolytic processing, phosphorylation, prenylation, racemization, selenoylation, sulfation, transfer-RNA mediated addition of amino acids to polypeptides such as arginylation, and ubiquitination. The term “protein” also includes “artificial proteins” which refers to linear or non-linear polypeptides, consisting of alternating repeats of a peptide.

Non-limiting examples of proteins include dairy based proteins, plant based proteins, animal based proteins and artificial proteins. Dairy based proteins may be selected from the group consisting of casein, caseinates, casein hydrolysate, whey, whey hydrolysates, whey concentrates, whey isolates, milk protein concentrate, milk protein isolate, or combinations thereof. Plant based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, and any proteins derived from beans, buckwheat, lentils, pulses, single cell proteins, or combinations thereof. Animal based proteins may be selected from the group consisting of beef, poultry, fish, lamb, seafood, or combinations thereof.

All dosage ranges contained within this application are intended to include all numbers, whole or fractions, contained within said range.

As used herein, the terms “treatment,” “treat” and “to alleviate” include both prophylactic or preventive treatment (that prevent and/or slow the development of a targeted pathologic condition or disorder) and curative, therapeutic or disease-modifying treatment, including therapeutic measures that cure, slow down, lessen symptoms of, and/or halt progression of a diagnosed pathologic condition or disorder; and treatment of patients at risk of contracting a disease or suspected to have contracted a disease, as well as patients who are ill or have been diagnosed as suffering from a disease or medical condition. The term does not necessarily imply that a subject is treated until total recovery. The terms “treatment” and “treat” also refer to the maintenance and/or promotion of health in an individual not suffering from a disease but who may be susceptible to the development of an unhealthy condition, such as nitrogen imbalance or muscle loss. The terms “treatment,” “treat” and “to alleviate” are also intended to include the potentiation or otherwise enhancement of one or more primary prophylactic or therapeutic measure. The terms “treatment,” “treat” and “to alleviate” are further intended to include the dietary management of a disease or condition or the dietary management for prophylaxis or prevention a disease or condition.

As used herein the term “vitamin” is understood to include any of various fat-soluble or water-soluble organic substances (non-limiting examples include vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, K1 and K2 (i.e. MK-4, MK-7), folic acid and biotin) essential in minute amounts for normal growth and activity of the body and obtained naturally from plant and animal foods or synthetically made, pro-vitamins, derivatives, analogs.

The present nutritional compositions are directed to nutritional compositions that are designed to provide adequate nutrition for performance and to be reconstituted in a liquid by the consumer prior to consumption. Power and/or performance bars are known in the art and are typically consumed by individuals requiring increased carbohydrate loads for improved or sustained athletic performance or increased mental alertness. These types of known performance bars, however, may suffer from certain limitations or pitfalls in the eyes of consumers.

For example, known performance bars may be heavy or dense or have a chalky or bland taste. Although the performance bars provide individuals with adequate nutrition for prolonged or endurance performance, the individual may not enjoy consuming these types of performance bars. Instead, the consumer may prefer a different source of adequate nutrition that is refreshing and easier to consume. As such, the nutritional compositions of the present disclosure provide formulations that can provide athletes very efficiently with carbohydrates and an increased rate of exogenous carbohydrate oxidation before or during exercise, while at the same time being enjoyable to make and consume.

While the nutritional compositions of the present disclosure are disclosed as being useful for consumption by athletes, it is, however, clear, that the nutritional compositions of the present disclosure can be used by anybody in need of carbohydrate supply. For example, the nutritional compositions of the present disclosure can be very well used as transportable food for people, who do not wish to carry too heavy provisions, for example during long term trips. The nutritional compositions of the present disclosure may equally well be used by people to provide the body with carbohydrates for example before or during an examination in school or at the university.

In an embodiment, nutritional compositions of the present disclosure are directed to powder compositions that have substantially the same nutritional content as known performance bars. One such performance bar is the PowerBar® Performance® Bar manufactured by Nestlé Nutrition. The powder compositions are designed to be reconstituted in water prior to consumption by the consumer. Although the nutritional compositions are disclosed herein as powder compositions that require reconstitution, the skilled artisan will immediately appreciate that the nutritional compositions may also be ready to drink compositions including the powder compositions disclosed herein already reconstituted in water. Such ready to drink compositions may be sold in different serving sizes depending on the carbohydrate load requirements. For example, the ready to drink compositions may be sold in serving sizes from about 4 fluid ounces to about 32 fluid ounces. In an embodiment, the ready to drink compositions are sold in serving sizes from about 8 fluid ounces to about 16 fluid ounces. In an embodiment, the ready to drink compositions are sold in serving sizes of about 12 fluid ounces.

Since performance bars typically include beneficial ingredients such as, for example, energy-rich cereals and fresh fruit, the nutritional compositions of the present disclosure are able to deliver the same beneficial ingredients but in powder form. In this manner, the consumer is able to obtain all of the benefits of the solid performance bar, but in a convenient and tasty drink after the powder is reconstituted in water or another suitable liquid such as, for example, fruit juice.

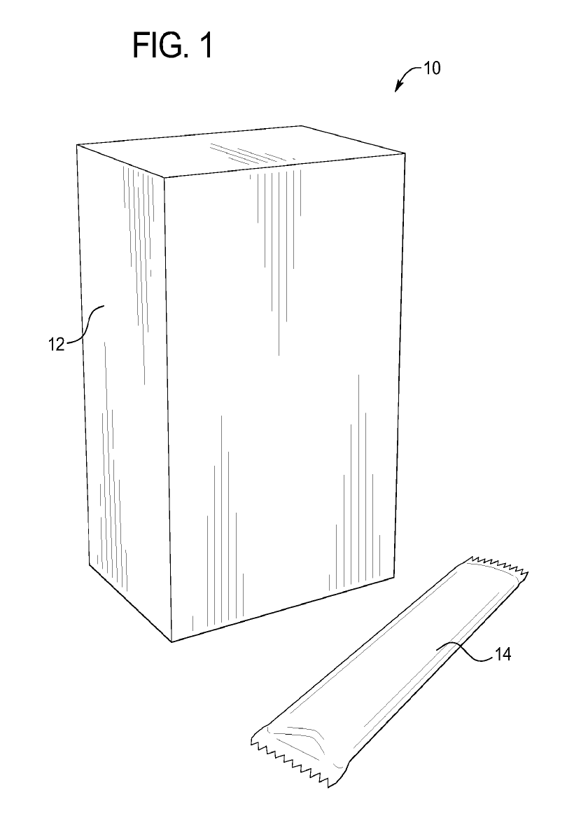

The powdered nutritional compositions of the present disclosure may be provided in several useful forms to the consumer. In a first embodiment, the powdered nutritional composition is packaged in individual sachets that are designed for individual use. For example, and as shown by FIG. 1, a retail package 10 for containing the powdered nutritional compositions includes an outer package 12 that is configured to hold multiple individual sachets 14, or packets, which contain the powdered nutritional composition (not shown). Outer package 12 may be any size and shape known in the art so long as outer package 12 is able to contain multiple individual sachets 14. Outer package 12 may be manufactured from a material such as paperboard, cardboard, plastic, metal, and the like. Outer package 12 may also include branding and/or product indicia on any exterior wall. The indicia may be printed thereon or adhered thereto with a sticker, adhesive label, etc. In this manner, outer package 12 may be designed to sit upright for display on a retail shelf

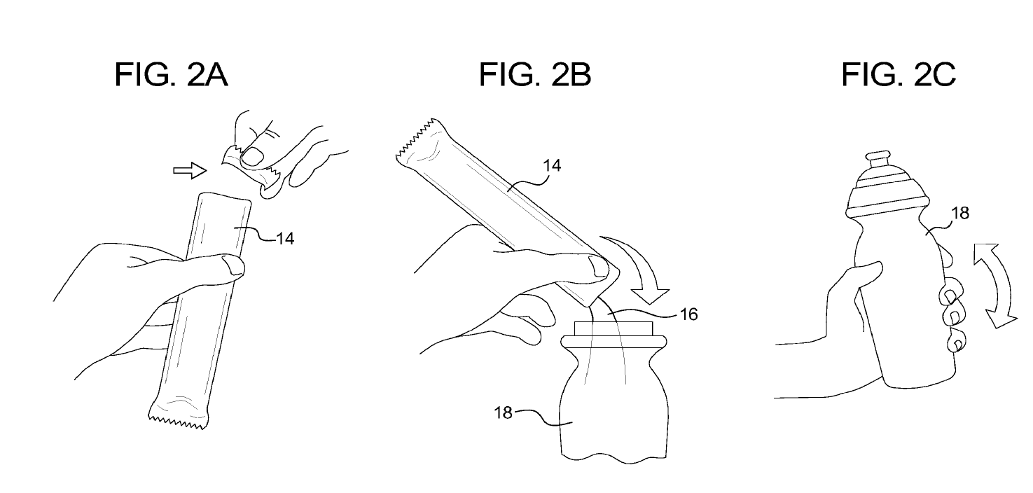

Individual sachets 14 may also be manufactured from a material such as paperboard, cardboard, plastic, and the like, and may also contain branding and/or product information or indicia thereon. Individual sachets 14 should be so constructed and arranged to be contained in outer package 12 and easily opened by a consumer to empty the contents therein. For example, to use individual sachets 14, the user may open an individual sachet 14 by tearing, puncturing or removing a portion of the wrapping, as shown by FIG. 2A, and emptying the powdered nutritional composition 16 from individual sachet 14 into a container 18, as shown by FIG. 2B. Container 18 may already contain a reconstitution liquid such as, for example, water or fruit juice, or may be filled with a reconstitution liquid after powdered nutritional composition 16 is emptied therein. As shown in FIG. 2C, to prepare the nutritional composition for consumption, the consumer can shake container 18 to thoroughly dissolve powdered nutritional composition 16 in the reconstitution liquid. After dissolution of the powdered nutritional composition 16, the nutritional drink is ready for consumption.

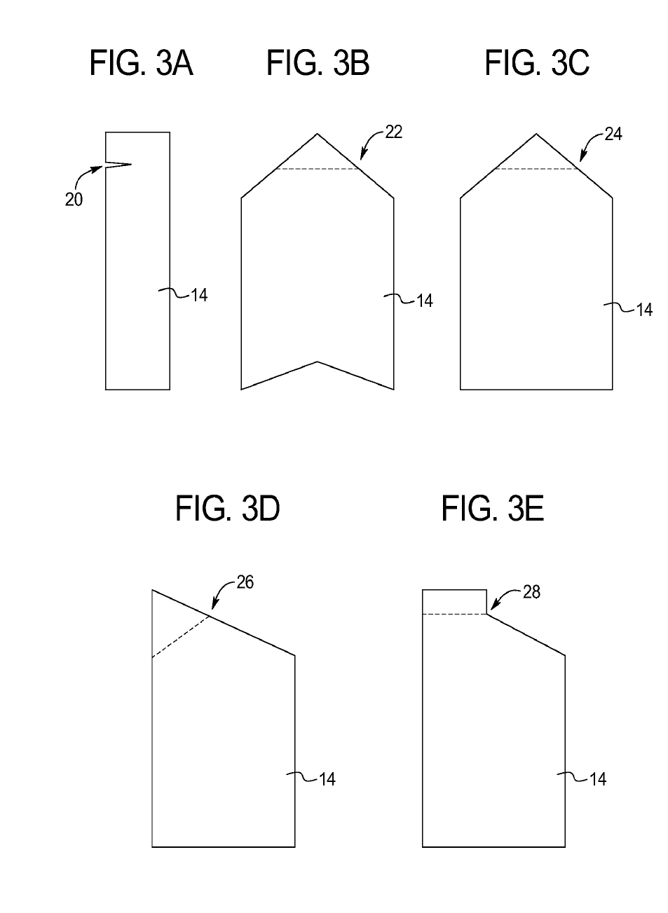

Sachets 14 may have any shape and size known in the art so long as sachets 14 are configured to contain the powdered nutritional composition 16 and be easily opened by a consumer to prepare a liquid nutritional composition. Examples of different configurations of sachets 14 are shown in FIGS. 3A-3E. FIG. 3A shows a substantially rectangular sachet 14 with a pre-formed tear notch 15. FIG. 3B illustrates a chevron, or arrow-shaped, sachet 14 with a pre-formed perforation 22. FIG. 3C illustrates a substantially rectangular sachet 14 with a triangular top portion and a preformed perforation 24. FIG. 3D illustrates a substantially rectangular sachet 14 with a slanted top portion and a pre-formed perforation 26. FIG. 3E illustrates a substantially rectangular sachet 14 with a slanted top portion also having a rectangular portion and a pre-formed perforation 28. Single serving sizes of the nutritional compositions contained in individual sachets 14 may range from about 1 g to about 20 g. In an embodiment, the serving sizes of the nutritional compositions contained in sachets 14 ranges from about 1 g to about 15 g, or from about 1 g to about 6 g, or about 3 g.

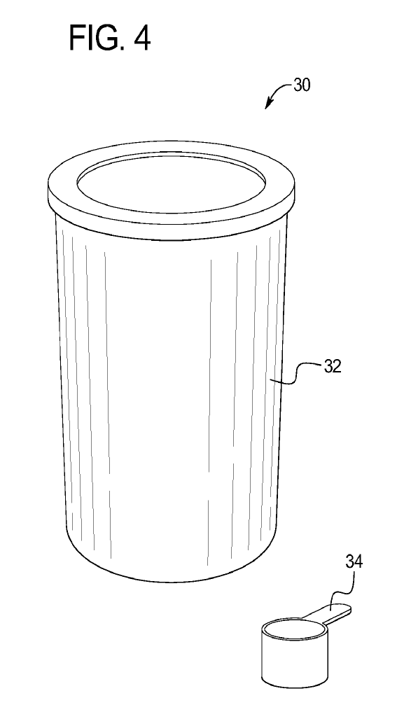

In another embodiment, and as shown in FIG. 4, a retail package 30 for containing the powdered nutritional composition includes an outer package 32 that contains the powdered nutritional composition (not shown). Outer package 32 may be any size or shape known in the art so long as outer package 32 is capable of containing multiple servings of the powdered nutritional composition. Outer package 32 may be manufactured from a material such as paperboard, cardboard, plastic, metal, and the like. In an embodiment, outer package 32 is constructed and arranged to directly contact the powdered nutritional composition contained therein. As such, in an embodiment, outer package 32 may include a food-grade coating on an interior surface

By providing individual packets 14 and/or retail package 30 with ladle 34, the consumer is able to prepare a liquid nutritional composition (e.g., beverage) that is exactly tailored to the consumer's carbohydrate needs. For example, for a normal workout, the consumer may use one individual sachet 14 dissolved in a single serving of reconstitution liquid. For a normal workout, the consumer may also use one scoop of the powdered nutritional composition from retail package 30 with ladle 34 dissolved in a single serving of reconstitution liquid. For a more rigorous workout, however, the consumer may choose to use two or more individual sachets 14 dissolved in a single serving of reconstitution liquid, or two or more scoops of the powdered nutritional composition from retail package 30 with ladle 34 dissolved in a single serving of reconstitution liquid. As such, the nutritional compositions of the present disclosure may be tailored to the individual needs of each athlete.

As mentioned previously, since performance bars typically include beneficial ingredients such as, for example, energy-rich cereals and fresh fruit, the powdered nutritional compositions of the present disclosure are able to deliver the same beneficial ingredients but in powder form. In this manner, the consumer is able to obtain all of the benefits of the solid performance bar, but in a convenient and tasty drink after the powder is reconstituted in water.

Applicant believes that an intake of even 90 grams of carbohydrate (“CHO”) per hour in the form of a liquid nutritional composition, as well as 30-60 g CHO/h as recommended by the American College of Sports Medicine, is well tolerable if ingested as carbohydrate mixture comprising glucose and fructose in a ratio in the range of 3:1 to 1:1, or more specifically 2:1. Additionally, the gastric tolerance of a liquid nutritional composition delivering a mixture of glucose and fructose at relatively high rates during a real life situation of either running or cycling outdoors.

Applicant further believes that the ingestion of 90 grams/h of the above carbohydrate mixture will allow to keep the distress of the GI-tract of athletes minimal, and at about a rate of 15% of subjects. Furthermore, it is believed that the minimal GI distress will not increase as compared with an intake of 60 grams of a carbohydrate mixture comprising glucose and fructose in a ratio in the range of 3:1 to 1:1, preferably 2:1 per hour.

Consequently, one embodiment of the present disclosure is a nutritional composition comprising a carbohydrate fraction comprising glucose and fructose in a ratio in the range of 3:1 to 1:1. The nutritional compositions of the present disclosure are food products, either (i) in powder form or (ii) in liquid form as the powdered nutritional compositions reconstituted in liquid, which comprises at least one carbohydrate source, and preferably a multiple carbohydrate source such as the combination of glucose and fructose, or maltodextrin and fructose.

The nutritional compositions may contain a grain or grains, nuts, possibly dried fruit, fruit paste, sweeteners and other ingredients. These ingredients can be mixed with a binder such as a sugar syrup or shortening and compressed, or pulverized, and dried to form a powder.

The multiple carbohydrate source may contain fructose and glucose in a digestible form. Glucose and/or fructose may be provided in the form of fructogenic and/or glucogenic carbohydrates. Fructogenic carbohydrates are carbohydrates which upon theoretical total hydrolysis release at least one fructose molecule. Glucogenic carbohydrates are carbohydrates which upon theoretical total hydrolysis release at least one glucose molecule. Consequently, a carbohydrate can be both, glucogenic and fructogenic (e.g., saccharose). For example in performance bars, glucogenic sources may be also extruded cereal pieces, cereal flakes, flours and starches.

Hence, the carbohydrates may comprise or consist of monosaccharides, such as glucose or fructose as basic carbohydrate units. The monosaccharides may represent a part of disaccharides, such as sucrose, lactose, maltose or cellobiose. The monosaccharides such as glucose or fructose may also represent a part of oligosaccharides or polysaccharides. Preferred carbohydrate sources for the present invention are maltodextrins and/or dextrose. The carbohydrate source may additionally comprise indigestible carbohydrates, in particular fibers.

The carbohydrate fraction of the nutritional compositions may comprise at least 30% glucose and fructose, preferably at least 50% glucose and fructose more preferably at least 85% glucose and fructose. In one embodiment of the present disclosure the carbohydrate fraction of the nutritional compositions provides at least 50%, preferably at least 70% of the energy of the nutritional composition.

The nutritional compositions of the present disclosure include a carbohydrate fraction and, optionally, a protein fraction and/or a fat fraction.

The presence of proteins and/or fats in the nutritional compositions of the present disclosure has the advantage that this way it is possible to provide the athlete with a more complete nutrition during performance. Furthermore, the presence of proteins allows producing a nutritional composition with a modified taste.

As protein source, any suitable dietary protein may be used, for example animal proteins (such as milk proteins, meat proteins and egg proteins); vegetable proteins (such as soy protein, wheat protein, rice protein, and pea protein); mixtures of free amino acids; or combinations thereof. In an embodiment, milk proteins such as casein and whey, and soy proteins are included in the nutritional compositions.

The proteins may be intact or hydrolyzed or a mixture of intact and hydrolyzed proteins. It may be desirable to supply partially hydrolyzed proteins (degree of hydrolysis between 2 and 20%), for example for athletes believed to be at risk of developing cows' milk allergy. Additionally, in generally at least partially hydrolyzed proteins are easier and faster to metabolize by the body. This is in particular true for amino acids. Consequently, it is further preferred if the nutritional compositions of the present disclosure contain single amino acids. In an embodiment, however, essential amino acids are included in the nutritional compositions. In one embodiment the nutritional compositions of the present disclosure contains amino acids such as L-leucine, L-valine and/or L-isoleucine.

If the composition includes a fat source, the fat source has the advantage that, for example, an improved mouth feel can be achieved. Any fat source is suitable. For example, animal or plant fats may be used. To increase the nutritional value, ω-3-unsaturated and ω-3-unsaturated fatty acids may be comprised by the fat source. The fat source may also contain long chain fatty acids and/or medium chain fatty acids. For example, milk fat, canola oil, almond butter, peanut butter, corn oil and/or high-oleic acid sunflower oil may be used.

Preferably, the nutritional compositions contain less than 40 g protein per 100 g nutritional composition and/or less than 20 g fat per 100 g nutritional composition.

The nutritional compositions may also contain minerals and micronutrients such as trace elements and vitamins in accordance with the recommendations of Government bodies such as the United States Recommended Daily Allowances (“USRDA”).

The nutritional compositions may contain vitamins, such as Vitamin C, Vitamin E, Vitamin B12, Niacin, Vitamin B6, folic acid, biotin, panthotenic acid, Vitamin B2 and/or Vitamin B6, preferably in amounts that correspond to at least 10% of the recommended daily dose. The presence of vitamins may contribute to the effectiveness of the nutritional composition and may further protect the athlete. For example, the presence of vitamin C will help to protect against catching a common cold. The nutritional compositions may also include electrolytes and/or minerals, such as sodium, potassium, calcium, iron, magnesium or zinc.

These nutritional compounds may be helpful to replenish the body with compounds that the person is constantly loosing due to the generation of sweat during exercise. They may also help to prevent the generation of post-exercise sore muscles.

The nutritional compositions of the present disclosure may further contain one or more compounds selected from the group consisting of aroma compounds, fiber, caffeine, guarana, acidifying agents, binding agents, gel building material, water, fruit juice, fruits, antioxidants, and coloring agents.

These agents may improve the nutritional compositions of the present disclosure with respect to many properties, such as taste, consistency, color, and stability during storage, digestibility, and many more that are known to those of skill in the art.

The energy density of the nutritional compositions is not critical for its effectiveness. However, a high energy density has the advantage that less food needs to be ingested to replenish carbohydrates as fuel to the body. Consequently, high energy densities are preferred for the nutritional compositions of the present disclosure.

In an embodiment of the present disclosure, the nutritional compositions have an energy density of about 800 to about 2200 kJ/100 g, or more specifically about 1000 to about 2000 kJ/100 g. In an embodiment, the nutritional compositions have an energy density of about 1200 to about 1800kJ/100 g.

To be easily consumable, for example, during a competition or in between competitions, the serving size of the nutritional compositions reconstituted in water is preferably relatively small. Preferably, the nutritional compositions, when present as a powdered nutritional composition reconstituted in liquid, have a serving size of about 4 fluid ounces to about 12 fluid ounces. In an embodiment, the nutritional compositions, when present as a powdered nutritional composition reconstituted in liquid, have a serving size of about 8 fluid ounces. For larger serving sizes, the nutritional compositions may be reconstituted in a liquid from about 12 to about 32 fluid ounces. In an embodiment, the nutritional compositions may be reconstituted in about 16 fluid ounces of liquid.

A typical nutritional composition of the present disclosure may comprise the following percentages of daily values (“DV”) based on a 2000 calorie diet: between 4 and 6% total fat, including between 1 and 3% saturated fats, between 5 and 9% sodium, between 0.5 and 1.5% potassium, between 12 and 16% carbohydrates, including between 5 and 10% glucose and fructose, and between 10 and 14% proteins.

Additionally it may comprise between 80 and 120% DV vitamin C, between 20 and 30% DV calcium, between 25 and 35% DV iron, between 80 and 120% DV vitamin E, between 80 and 120% DV thiamin, between 80 and 120% DV riboflavin, between 80 and 120% DV niacin, between 80 and 120% DV vitamin B6, between 80 and 120% DV folate, between 80 and 120% DV vitamin B12, between 80 and 120% DV biotin, between 80 and 120% DV pantothenic acid, between 20 and 30% DV phosphorus, between 20 and 30% DV magnesium, between 25 and 35% DV zinc, between 25 and 35% copper, and between 15 and 25% DV chromium.

The nutritional composition of the present disclosure may be used, for example, as a food product, as a food additive or as a nutraceutical.

In an embodiment of the present disclosure the nutritional compositions of the present disclosure are used for the preparation of a food product or as a food product to provide an increased performance, in particular endurance performance.

The formulation of nutritional compositions of the present disclosure may also be used to provide an increased carbohydrate delivery without any increased gastrointestinal disorders and/or to treat or prevent problems with the gastrointestinal tract.

The combination of glucose and fructose in the nutritional compositions of the present disclosure allows the high carbohydrate content of the nutritional compositions is well tolerated by the body, so that problems of the gastrointestinal tract that one would normally expect after a high level of carbohydrate intake during exercise are at least partially avoided. Also, the gastrointestinal tolerance for carbohydrates, in particular the glucose/fructose mixture of the present disclosure will be increased.

The problems with the gastrointestinal tract as mentioned above are not particularly limited but are preferably selected from the group consisting of upper abdominal problems such as reflux, heartburn, bloating, upper abdominal cramps, vomiting, nausea; lower abdominal problems such as intestinal cramps, flatulence, urge to defecate, left abdominal pain, right abdominal pain, loose stool, diarrhea; or systemic problems such as dizziness, headache, muscle cramp or urge to urinate.

For exercise in general, but in particular for competitive exercise it is essential that the body has blood sugar available for the muscles to burn at all times. In particular at the end of a race it must be avoided, or the athlete will run out of energy. The subject matter of the present disclosure is well suited to prevent this. According to one embodiment of the present disclosure, the nutritional compositions of the present disclosure can be used to allow for an enhanced blood sugar maintenance late in exercise.

The present nutritional compositions cannot only secure a long lasting blood sugar maintenance, it can also be used to provide an increased exogenous carbohydrate oxidation. Increasing exogenous carbohydrate oxidation was found to be in particular increased if the carbohydrate uptake of a person is greater than 1 g/min, preferably greater than 1.1 g/min even more preferred greater than 1.2 g/min.

Consequently, surprisingly, optimal exogenous carbohydrate oxidation is reached at a carbohydrate ingestion above the theoretical threshold once thought for carbohydrate oxidation. See, Jeukendrup A E and Jentjens R., Sports Med 29: 407-424 (2000). This way, the energy delivery from carbohydrates during physical exercise can be maximized.

Further, the present nutritional compositions may be used to provide faster energy delivery, in particular to working muscles, and/or to provide more sustained energy to muscles. Both effects will contribute to an optimal performance of an athlete.

The present nutritional compositions may also be used to treat or prevent symptoms of fatigue and/or to improve cycling cadence, for example measured in revolutions per minute and/or to decrease ratings of perceived exertion (“RPE”).

Applicant has found that the above listed uses can be successfully carried out with any amounts of carbohydrates comprising glucose and fructose in a ratio of 3:1 to 1:1 to be ingested. However, Applicant believes that best results may be obtained, when the nutritional compositions are used in an amount that corresponds to an ingestion of at least 30 g CHO/h, preferably at least 50 g CHO/h, more preferably at least 65 g CHO/h and most preferably between 80 g CHO/h and 110 g CHO/h.

The higher the amount of carbohydrates ingested per hour is, the more the exogenous carbohydrate oxidation can be increased. Applicant believes that a maximum of exogenous carbohydrate oxidation will be reached when the nutritional compositions are consumed so that 100 g-150 g carbohydrates are consumed per hour, preferably 110 g-130 g carbohydrates per hour and most preferred 115 g-125 g carbohydrates per hour.

The nutritional compositions of the present disclosure provide a convenient, portable and easy-to-consume way to deliver the nutritional benefits of cereals and fruits, in the same manner as solid performance bars. The nutritional compositions combine adequate nutrition and hydration, which are two key elements for high-performance workouts. In addition, the nutritional compositions are customizable to deliver the exact nutrition and/or carbohydrate load required by each specific consumer.

By way of example and not limitation, the following examples are illustrative of various embodiments of the present disclosure. The formulations below are provided for exemplification only, and they can be modified by the skilled artisan to the necessary extent, depending on the special features that are desired.

### EXAMPLES

### Example 1

Table 1 illustrates a comparison between a PowerBar® Performance® Bar manufactured by Nestlé Nutrition and a powdered nutritional composition of the present disclosure. As can be seen in Table 1, the powdered nutritional composition of the present disclosure is comparable to the PowerBar® Performance® Bar.

TABLE 1

| | Berry PowerBar ® | Powdered |
|---|---|---|
| | Performance ® | Nutritional |
| Ingredient | Bar | Composition |
| Maltodextrin Powder DE15 | 22.474 | 22.863 |
| Syrup Evp Cane Juice | 21.142 | |
| Sugar White | | 22.316 |
| Fruit Mix Strawberry | 14.064 | |
| Cranberry | | |
| Apple Paste | 5.861 | |
| Strawberry Powder | | 19.881 |
| Protein Milk Isolate | 9.349 | 10.934 |
| Oat Flakes | 4.655 | 7.952 |
| Dextrose Powder | 6.839 | 6.958 |
| Fructose Powder | 5.861 | 5.964 |
| Acid Citric | 0.553 | 1.193 |
| Flavor Berry | 0.613 | 0.696 |
| Color Red | 0.465 | 0.497 |
| Salt NaCl | 0.346 | 0.348 |
| Oil Canola | 4.517 | |
| Vitamin Mineral Premix | 2.886 | |
| Lecithin | 0.376 | |
| Gum Xanthan | | 0.398 |
| Total | 100.00 | 100.00 |

### Example 2

### Female Cyclist

In a first performance example, the consumer is a female cyclist. The consumer weighs about 50 kg and is cycling at a rate of about 9 km per hour. For this specific exercise profile, it is estimated that the energy expenditure of the female cycler is about 3.5 kcal per minute (210 kcal per hour). Based on the estimated energy costs and weight of the cyclist, it is proposed that the female cyclist should consume about 50 g of a powdered nutritional compositions of the present disclosure dissolved in about 100 mL of water.

### Example 3

### Male Runner/Jogger

In a second performance example, the consumer is a male runner/jogger. The consumer weighs about 60 kg. For this specific exercise profile, it is estimated that the energy expenditure of the male runner/jogger is about 7 kcal per minute (630 kcal per 90 minutes). Based on the estimated energy costs and weight of the runner/jogger, it is proposed that the male runner/jogger should consumer about 150 g of a powdered nutritional composition of the present disclosure dissolved in about 300 mL of water.

### Example 4

### Male Cyclist

In a third performance example, the consumer is a male cyclist. The consumer weighs about 80 kg and is cycling at a rate that is common for a racing cyclist. For this specific exercise profile, it is estimated that the energy expenditure of the male cycler is about 14 kcal per minute (840 kcal per hour). Based on the estimated energy costs and weight of the cyclist, it is proposed that the male cyclist should consume about 220 g of a powdered nutritional compositions of the present disclosure dissolved in about 300 mL of water.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nutritional composition comprising a carbohydrate fraction comprising glucose and fructose in a ratio from about 3:1 to about 1:1, wherein:
the powder nutritional composition is designed to be dissolved in water,
a serving size of the nutritional composition is from about 1 to about 20 g the carbohydrate fraction comprises at least 30% glucose and fructose,
the carbohydrate fraction provides at least 50% of the energy of the nutritional composition; and
the nutritional composition comprises an energy density from about 800 kJ/100 g to about 2200 kJ/100 g.

2. The nutritional composition according to claim 1, wherein the carbohydrate fraction comprises dextrose and/or maltodextrins.

3. The nutritional composition according to claim 1,wherein the nutritional composition comprises less than 40 g protein per 100 g nutritional composition.

4. The nutritional composition according to claim 1, wherein the nutritional composition comprises less than 20 g fat per 100 g nutritional composition.

5. The nutritional composition according to claim 1, further comprising at least one of:
At least one vitamin selected from the group consisting of vitamin C, vitamin E, vitamin B12, niacin, vitamin B6, folic acid, biotin, panthotenic acid, vitamin B2, vitamin B6, and combinations thereof;
at least one electrolyte or mineral selected from the group consisting of sodium, potassium, calcium, iron, magnesium, zinc, and combinations thereof;
at least one amino acid selected from the group consisting of L-leucine, L-valine, L-isoleucine, and combinations thereof; and
at least one compound selected from the group consisting of aroma compounds, fiber, caffeine, guarana, acidifying agents, binding agents, gel building material, fruit, antioxidants, colorings agents, and combinations thereof.

6. The nutritional composition according to claim 1, wherein the nutritional composition is a powder.

7. The nutritional composition according to claim 1, wherein the nutritional composition is a liquid.

8. A packaged food product comprising:
an outer package that is so constructed and arranged to house a plurality of inner packages, each inner package containing a nutritional composition, the nutritional composition selected from the group consisting of those claimed in claim 1 to claim 7.

9. The packaged food product according to claim 9, wherein the outer package is manufactured from a material selected from the group consisting of paperboard, cardboard, plastic, metal and combinations thereof.

10. The packaged food product according to claim 9, wherein the plurality of inner packages comprises from about 5 to about 20 inner packages.

11. The packaged food product according to claim 9, wherein each of the plurality of inner packages includes one serving size of the nutritional composition.

12. A method for making a liquid nutritional composition, the method comprising the steps of:
dispensing a powdered nutritional composition from a first container into a second container, the powdered nutritional composition selected from a group consisting of those claimed in claim 1 to claim 6; and
combining the powdered nutritional composition in the container with a liquid to form a liquid nutritional composition.

13. The method according to claim 12, wherein the liquid is selected from the group consisting of water, fruit juice, and combinations thereof.

14. The method according to claim 12, further comprising the step of removing the single serving sized packet from an outer package.

15. The method according to claim 12, wherein the outer package is manufactured from a material selected from the group consisting of paperboard, cardboard, plastic, metal and combinations thereof.

16. The method according to claim 12, wherein the dispensing a powdered nutritional composition from a first container into a second container is emptying a powdered nutritional composition from a single serving sized packet into a container.

17. The method according to claim 12, wherein the first container is so constructed and arranged to contain multiple servings of the powdered nutritional composition.

18. The method according to claim 12, wherein the first container comprises a food grade coating on an interior surface.

19. A method for improving performance in an individual in need of same, the method comprising the steps of:
administering the nutritional composition selected from the group consisting of those claimed in claim 1 to claim 7, to the individual.

20. The method according to claim 19, wherein the performance is selected from the group consisting of athletic, academic, endurance, and combinations thereof.

21. The method according to claim 19, wherein the improving performance comprises providing sustained energy to muscles in an individual.

22. The method according to claim 19, wherein the improving performance comprises providing an adequate carbohydrate load to an individual in need of same.

23. The method according to claim 22, wherein the individual is an athlete.
